(19) United States
(12) Patent Application Publication
(10) Pub. No.: US 2021/0060849 A1
(43) Pub. Date: Mar. 4, 2021

(54) FABRICATION OF CONDUCTIVE COILS BY ADDITIVE MANUFACTURING

(71) Applicant: IO Tech Group Ltd., London (GB)

(72) Inventor: Michael Zenou, Hashimonaim (IL)

(21) Appl. No.: 16/946,638

(22) Filed: Jun. 30, 2020

Related U.S. Application Data
(60) Provisional application No. 62/892,079, filed on Aug. 27, 2019.

(51) Int. Cl. B29C 64/10; B33Y 10/00; B33Y 80/00; B29C 64/40; B22F 3/105

(52) U.S. Cl. CPC B29C 64/10; B33Y 10/00; B29L 2031/711; B29C 64/40; B22F 3/1055; B33Y 80/00

(57) ABSTRACT

A conductive coil fabricated by an additive manufacturing process. The coil is printed as a plurality of partially complete rounds, each printed as at least a portion of a respective layer of material. Pillars interconnecting successive ones of the partially complete rounds in different ones of the respective layers of material are also printed and may be staggered across a circumference of the partially complete rounds. Scaffolding elements such as a supporting material matrix and/or a core internal to the partially complete rounds of the coil may be printed as part of each respective layer of material concurrently with printing the plurality of partially complete rounds.

### RELATED APPLICATIONS

This is a NONPROVISIONAL of, claims priority to, and incorporates by reference U.S. Provisional Application No. 62/892,079, filed 27 Aug. 2019.

### FIELD OF THE INVENTION

The present invention relates to methods of fabricating conductive coils by additive manufacturing techniques.

### BACKGROUND

Conductive coils find application in a variety of fields as components of electric circuits. For example, such coils may be used as components of electromagnets, inductors, transformers, transducers, and electric machines. With the advent of additive manufacturing technologies there have been efforts to fabricate conductive coils by, for example, extrusion, powdered metal sintering, and metal ink-jet printing. Metal ink-jet printing is a form of metal deposition in which a metal source such as a thin wire or foil is heated, for example by a laser beam, to create metal droplets which are directed by gravity and/or electromagnetic fields to a substrate. Metal deposition, extrusion, powdered metal sintering, and other forms of additive manufacturing build three dimensional articles from digital files describing those articles by successively adding material layer-by-layer in a pattern defined by the digital file.

Referring to FIGS. 1A and 1B, in the case of a conductive coil 10 individual coil elements 12a, 12b, 12c, . . . 12n, are printed in successive layers so as to partially overlap a most-recently printed element and thereby define a helical pattern of coil elements that collectively make up the conductive coil 10. In some cases, the coil elements 12a-12n are printed within a supporting material matrix 14 and/or about an inner core 16, which act as scaffolds to keep the coil under construction intact as the coil elements fuse with one another. The material matrix 14 and core 16 are removed post-printing. Each coil element 12a-12n is a few voxels in size.

FIGS. 2A and 2B further illustrate the layer-by-layer nature of the printing of the coil elements. For each layer 20a, 20b, . . . 20n of the print process, a portion of the layer is made up of a respective coil element 12a, 12b, . . . 12n, and a respective supporting material element 14a, 14b, . . . 14n. For each successive layer, the respective coil elements have a width “D” and overlap one another by an amount “a”. The layers have thickness “h”. For a given coil of radius R3, the supporting material matrix may be printed with an inner diameter R₁ (which is also the diameter of the inner core 16 if present) and outer diameter R₂. As shown in FIG. 3A, such a geometry limits the number of turns per unit length of the coil 10 as the distance “hₑ” between successive turns of the coil is given by:

$${h}_{n} = \frac{2 π {R}_{3} h}{( 1 - α ) D}$$

The chart in FIG. 3B illustrates the effect of the coil diameter D on the “thickness” hₙ of a single turn of a coil for different values of R3 for the case of a layer thickness h of 50 μm.

### SUMMARY OF THE INVENTION

Embodiments of the present invention include methods of fabricating a conductive coil by an additive manufacturing process. In one such method, a coil is printed as a plurality of partially complete rounds. Each partially complete round is printed by the additive manufacturing process as at least a portion of a respective layer of material. Also printed are pillars interconnecting successive ones of the partially complete rounds in different ones of the respective layers of material. The pillars may be vertical, or near-vertical. Positions of the pillars between successive ones of the plurality of partially complete rounds may be staggered across the circumference of the partially complete rounds. In some cases, following printing of one of the plurality of partially complete rounds in a respective layer of material, for a number of successive layers of material corresponding to a desired pillar height, only a connecting pillar is printed.

In some embodiments, scaffolding elements may be printed as part of each respective layer of material concurrently with printing the plurality of partially complete rounds. Such scaffolding elements may include a supporting material matrix and/or a core internal to the partially complete rounds of the coil.

For each successive partially complete round, that successive partially complete round is preferably printed such that it overlaps a last printed one of the pillars. As indicated, positions of the pillars between successive ones of the plurality of partially complete rounds may be staggered across the circumference of the partially complete rounds by an azimuthal separation distance from an immediately previous pillar. Further, some of the pillars interconnecting successive ones of the partially complete rounds may be printed to different heights than others of the pillars interconnecting successive ones of the partially complete rounds.

In some embodiments, within each respective layer of material, concentric ones of the plurality of partially complete rounds may be printed offset from one another, and the pillars interconnecting successive ones of the partially complete rounds of each of concentric ones of the plurality of partially complete rounds may be printed so as to interconnect those of the partially complete rounds having a common radius. A connection between the concentric ones of the plurality of partially complete rounds is printed to form a junction (often only a single junction) between the concentric ones of the plurality of partially complete rounds. The junction may be near one end of columns of the concentric ones of the plurality of partially complete rounds. In some embodiments, the concentric ones of the plurality of partially complete rounds are offset from one another by a common radial distance. However, in other embodiments, the concentric ones of the plurality of partially complete rounds are printed about different centers.

Again, the pillars may be vertical, or near-vertical, and positions of the pillars between successive ones of the plurality of partially complete rounds of each of concentric ones of the plurality of partially complete rounds may be staggered across the circumference of the partially complete rounds. As in other embodiments, scaffolding elements (e.g., a supporting material matrix and/or a core internal to the partially complete rounds of the coil) may be printed as part of each respective layer of material concurrently with printing the concentric ones of the plurality of partially complete rounds. And, some of the pillars interconnecting successive ones of the partially complete rounds of each of concentric ones of the plurality of partially complete rounds may be printed to different heights than others of the pillars interconnecting successive ones of the partially complete rounds.

### BRIEF DESCRIPTION OF THE DRAWINGS

The present invention is illustrated by way of example, and not limitation, in the figures of the accompanying drawings, in which:

FIGS. 1A and 1B illustrate examples of a conductive coil formed by successively printing material, layer-by-layer in a pattern.

FIGS. 2A and 2B further illustrate the layer-by-layer nature of the printing of the coil elements of the coil illustrated in FIGS. 1A and 1B.

FIG. 3A illustrates how the geometry of a coil limits the number of turns per unit length of the coil as the distance “hₐ” between successive turns is varied.

The chart in FIG. 3B illustrates the effect of coil diameter D on the “thickness” hₙ of a single turn of a coil for different radial values.

FIGS. 4A and 4B illustrate examples of coils printed as nearly complete rounds within a layer, with successive rounds being interconnected by vertical, or near-vertical, pillars in accordance with an embodiment of the present invention.

FIGS. 5A-5C illustrate the effect of varying pillar height, hₚ, for coils fashioned as shown in FIGS. 4A and 4B.

FIGS. 6A-6D show a further embodiment of the invention in which concentric coil columns are printed one about another.

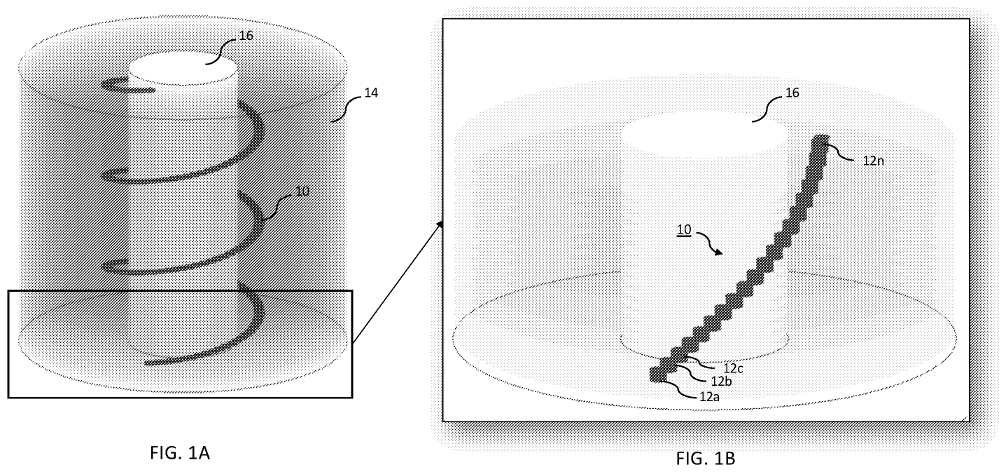

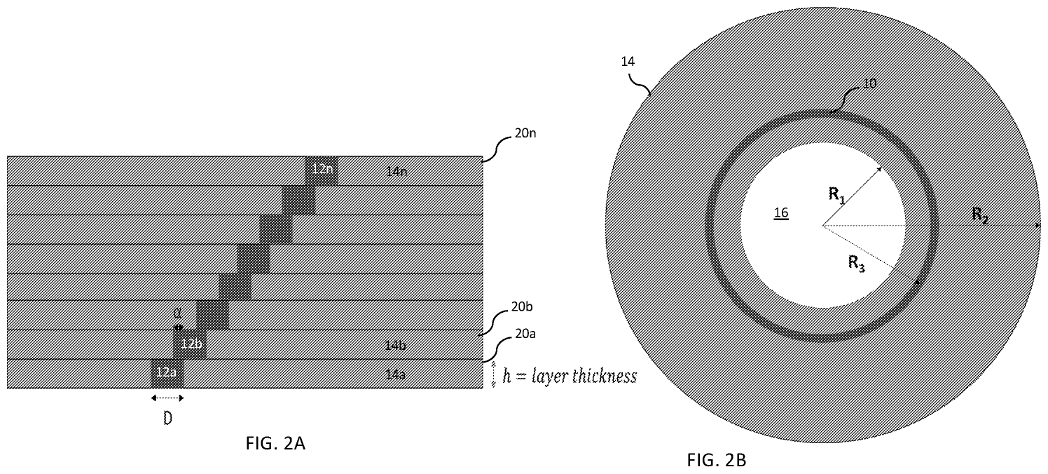

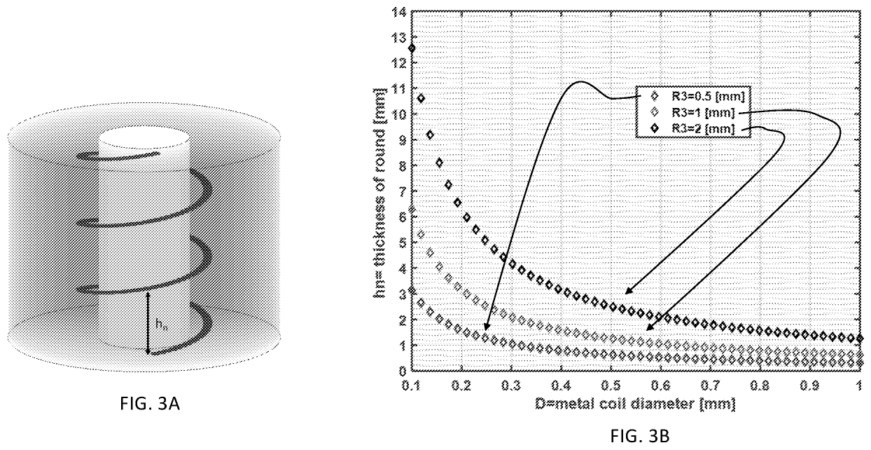

### DESCRIPTION

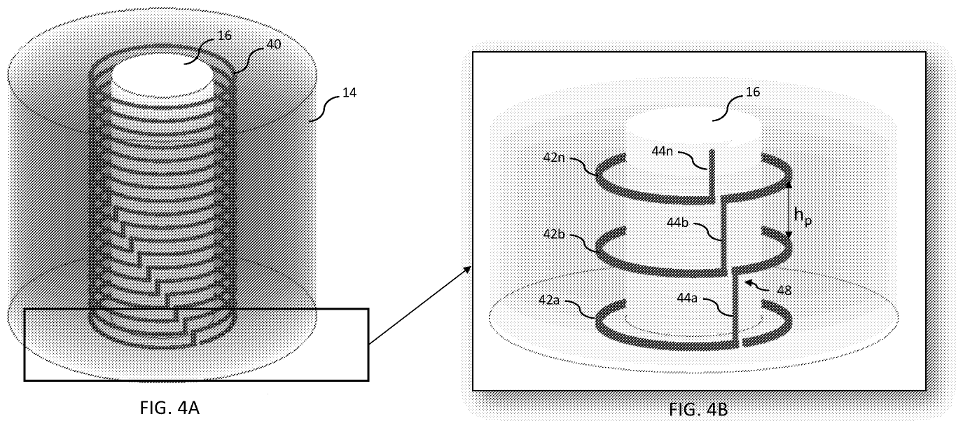

Described herein are new methods of fabricating conductive coils by additive manufacturing techniques. Referring to FIGS. 4A and 4B, in one embodiment of the invention coils 40 are printed as nearly complete rounds 42a, 42b, . . . 42n, each within a single layer, with successive rounds being interconnected by vertical, or near-vertical, pillars 44a, 44b, . . . 44n. By varying the height “hₚ” of a connecting pillar 44n, the density of the rounds can be varied/controlled. As shown in FIG. 4A, the positioning of pillars 44a, . . . 44n between successive rounds 42a, . . . 42n can be staggered across the circumference of the rounds so that electrical shorts are avoided and packing density of the rounds can be varied.

In one embodiment of the invention, a nearly complete round 42a, 42b, . . . 42n is printed in a layer. Then for a number of successive layers equal to a desired pillar height hₚ, only the connecting pillar 44a, 44, . . . 44n is printed. Scaffolding elements such as a supporting material matrix 14 and/or inner core 16 may also be printed as part of each layer. When a desired pillar height hₚ has been reached, another nearly complete round 42a, 42b, . . . 42n is printed, taking care to ensure that the new round overlaps the last printed connecting pillar segment, and the process repeats. As noted above, for each successive connecting pillar 44a, 44, . . . 44n that is printed, its location may be offset by a desired azimuthal separation distance from an immediately previous pillar. The result for a number of layers printed in succession is a pattern resembling overlaid rounds with notched or stepped portions 48 that proceed in a diagonal fashion over a vertical segment of the coil 40. The stepped portions 48 are defined by gaps in the rounds.

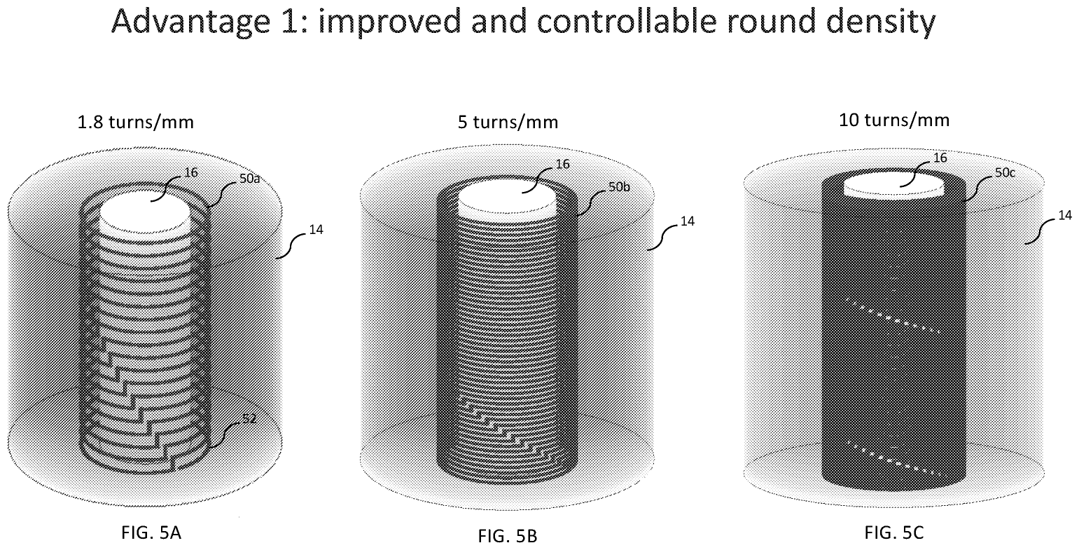

FIGS. 5A-5C illustrate the effect of varying the pillar height hₚ. In FIG. 5A, a coil 50a is fashioned with a pillar height hₚ that corresponds to a density of 1.8 turns/mm; that is, 1.8 rounds 52 per millimeter of displacement from a selected starting round. In FIG. 5b, the pillar height hₚ has been reduced, thereby increasing the coil density to 5 turns/mm. And, in FIG. 5C, the pillar height hₚ has been further reduced, increasing the coil density to 10 turns/mm. Coils of different densities may thus be fashioned by printing connecting pillars of different heights. Usually, the density of a coil will not vary (at least not intentionally so) over its length, however, this need not necessarily always be the case. Indeed, in some embodiments a single coil having different densities throughout its length may be fashioned by printing sections of the coil with connecting pillars of different heights than are found in other sections of the coil. Such a coil may find application where shaping of a magnetic field, e.g., in terms of magnetic flux lines and/or field strengths, is desirable.

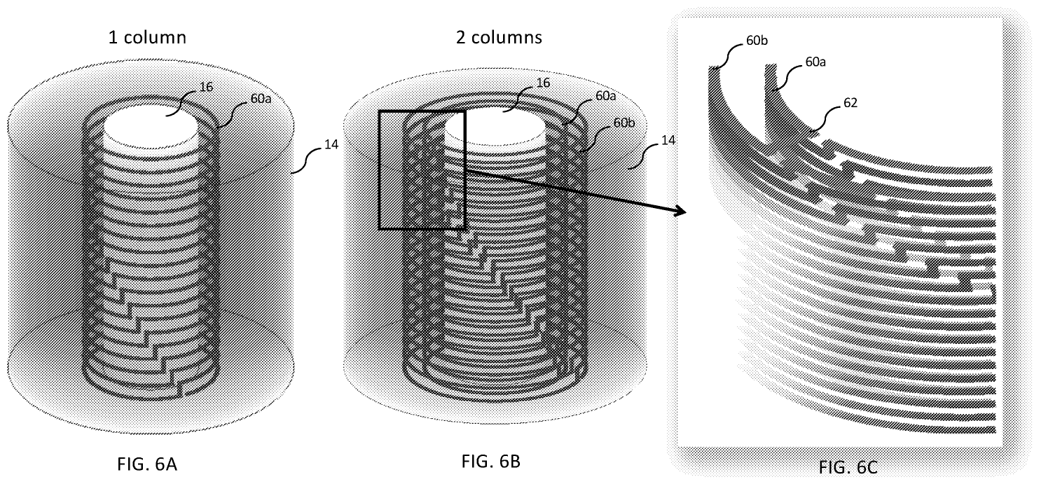

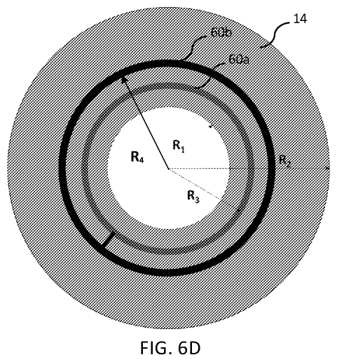

FIGS. 6A-6D show a further embodiment of the invention where concentric coil columns 60a, 60b are printed one about another. As illustrated in FIG. 6C, the two columns are connected to one another at a single junction 62 at or near one end of the concentric columns. Within each layer, inner coil 60a is printed with rounds having a radius R3, while the outer coil 60b is printed with rounds having a radius R4. For each layer, the supporting structure 14 is printed as a cross-section of a hollow cylinder with inner radius R₁ and outer radius R2. In some cases, the cylinder of supporting material need not be hollow, or the inner portion of the cylinder of supporting material may be formed of an inner core of radius R₁ of different material.

Although this example illustrates two concentric coils, in other embodiments varying numbers of concentric coil columns may be printed to provide desired characteristics. Each coil column so printed is fashioned so that successive connecting pillars of the rounds are offset by desired azimuthal separation distances from an immediately previous pillar. As with the example in FIGS. 5A-5C, the pillar separation distances may be maintained constant over an individual coil column, or they may be varied over the length of a coil column, again to provide designed electromagnetic characteristics. The azimuthal positions of the connecting pillars of different coil columns may be the same for each corresponding round along the lengths of the respective coil columns, or they may be different. Also, the coils may be printed about a common center or about different centers so as to provide desired magnetic field characteristics when used.

The printing techniques described herein may be used in connection with any additive manufacturing technique in which the three dimensional coil is formed layer-by-layer through material deposition, accretion, growth, etc., according to pattern cross-sections describing those layers as stored in a digital file. Thus, the present techniques may be used with, for example, extrusion or other forms of fused deposition modeling, sintering, metal ink-jet printing and other forms of metal deposition, as well as stereolithography, digital light processing, laminated object manufacturing, or forms of laser melting. In addition, although the forgoing discussion related to conductive metal coils, in general the techniques described herein may be used to fashion coils from materials other than conductors, for example, polymers.

Thus, methods of fabricating conductive coils by additive manufacturing techniques have been described.

What is claimed is:

1. A method of fabricating a conductive coil by an additive manufacturing process, the method comprising printing said coil as a plurality of partially complete rounds, each partially complete round printed by the additive manufacturing process as at least a portion of a respective layer of material, and printing pillars interconnecting successive ones of the partially complete rounds in different ones of the respective layers of material.

2. The method of claim 1, wherein the pillars are vertical, or near-vertical.

3. The method of claim 2, wherein positions of the pillars between successive ones of the plurality of partially complete rounds are staggered across the circumference of the partially complete rounds.

4. The method of claim 2, wherein following printing of one of the plurality of partially complete rounds in a respective layer of material, for a number of successive layers of material corresponding to a desired pillar height, printing only a connecting pillar.

5. The method of claim 1, further comprising printing scaffolding elements as part of each respective layer of material concurrently with printing the plurality of partially complete rounds.

6. The method of claim 5, wherein the scaffolding elements comprise at least one of a supporting material matrix and a core internal to the partially complete rounds of the coil.

7. The method of claim 1, wherein for each successive partially complete round, printing said successive partially complete round such that it overlaps a last printed one of the pillars.

8. The method of claim 7, wherein positions of the pillars between successive ones of the plurality of partially complete rounds are staggered across a circumference of the partially complete rounds by an azimuthal separation distance from an immediately previous pillar.

9. The method of claim 1, wherein some of the pillars interconnecting successive ones of the partially complete rounds are printed to different heights than others of the pillars interconnecting successive ones of the partially complete rounds.

10. The method of claim 1, wherein within each respective layer of material, printing concentric ones of the plurality of partially complete rounds offset from one another, printing the pillars interconnecting successive ones of the partially complete rounds of each of concentric ones of the plurality of partially complete rounds so as to interconnect those of the partially complete rounds having a common radius, and printing a connection between the concentric ones of the plurality of partially complete rounds at a junction.

11. The method of claim 10, wherein the pillars are vertical, or near-vertical.

12. The method of claim 11, wherein positions of the pillars between successive ones of the plurality of partially complete rounds of each of concentric ones of the plurality of partially complete rounds are staggered across a circumference of the partially complete rounds.

13. The method of claim 10, further comprising printing scaffolding elements as part of each respective layer of material concurrently with printing the concentric ones of the plurality of partially complete rounds.

14. The method of claim 13, wherein the scaffolding elements comprise at least one of a supporting material matrix and a core internal to the partially complete rounds of the coil.

15. The method of claim 10, wherein the junction is a single junction.

16. The method of claim 10, wherein the junction is near one end of columns of the concentric ones of the plurality of partially complete rounds.

17. The method of claim 10, wherein some of the pillars interconnecting successive ones of the partially complete rounds of each of concentric ones of the plurality of partially complete rounds are printed to different heights than others of the pillars interconnecting successive ones of the partially complete rounds.

18. The method of claim 17, wherein positions of the pillars between successive ones of the plurality of partially complete rounds of each of concentric ones of the plurality of partially complete rounds are staggered across a circumference of the partially complete rounds.

19. The method of claim 10, wherein within each respective layer of material, the concentric ones of the plurality of partially complete rounds are offset from one another by a common radial distance.

20. The method of claim 10, wherein within each respective layer of material, the concentric ones of the plurality of partially complete rounds are printed about different centers.
